(19) United States
(12) Patent Application Publication
(10) Pub. No.: US 2024/0004363 A1
(43) Pub. Date: Jan. 4, 2024

(54) CONTROLLING THE MOVEMENT OF AN OBJECT

(71) Applicant: B&R INDUSTRIAL AUTOMATION GMBH, Eggelsberg (AT)

(72) Inventors: Matthias NEUBAUER, Eggelsberg (AT); Wolfgang HÖBARTH, Eggelsberg (AT); Lukas MEßNER, Eggelsberg (AT); Dominik KASERER, Eggelsberg (AT)

(73) Assignee: B&R INDUSTRIAL AUTOMATION GMBH, Eggelsberg (AT)

(21) Appl. No.: 18/038,872

(22) PCT Filed: Nov. 24, 2021
(86) PCT No.: PCT/EP2021/082816

§ 371 Date: May 25, 2023

(30) Foreign Application Priority Data
Nov. 26, 2020 (AT) A51033/2020

(51) Int. Cl. G05B 19/23

(52) U.S. Cl. CPC G05B 19/231

(57) ABSTRACT

For improved control and planning of a movement of the object in relation to a transport unit of a transport system, the transport unit is moved along a predefined transport trajectory with respect to a reference coordinate system. Embodiments provide a synchronous phase, in which a movement of an object point of the object along an object path with respect to a transport unit coordinate system, different from the reference coordinate system, is predefined during the synchronous phase. The transport unit coordinate system containing the transport unit is moved along the transport trajectory. At least one path point of the object path is converted from the transport unit coordinate system to a base coordinate system in order to control the movement of the object point along the object path with respect to the base coordinate system.

The present invention relates to a method for controlling the movement of an object in relation to a transport unit of a transport system, wherein the transport unit is moved along a predefined transport trajectory with respect to a reference coordinate system. Furthermore, the present invention relates to a system comprising a transport system having a transport unit moved along a transport trajectory predefined with respect to a reference coordinate system and an object moved in relation to the transport unit.

In transport systems, a transport unit is moved along a transport trajectory, wherein the transport trajectory can be viewed, for example, in relation to a reference coordinate system. For example, electromagnetic transport systems such as long stator linear motors or planar motors can be provided. In the case of a long stator linear motor, a transport path is provided along which at least a part of the transport trajectory runs. In the case of a planar motor, at least a part of the transport trajectory runs in a transport plane. It may also be necessary to move an object along an object path on the transport unit. Because the transport unit itself performs a movement, the transport trajectory must also be taken into account when controlling the object path. Accordingly, U.S. Pat. No. 10,261,491 B1 proposes determining the object path and the transport trajectory directly with respect to the reference coordinate system. However, the object path can therefore only be planned together with the transport trajectory.

It is an object of the present invention to enable improved control and planning of an object path along a transport trajectory.

This object is achieved by providing a synchronous phase, wherein a movement of an object point of the object along an object path in relation to a transport unit coordinate system, different from the reference coordinate system, is predefined during the synchronous phase, wherein the transport unit coordinate system is moved along the transport trajectory with the transport unit, and at least one path point of the object path is converted from the transport unit coordinate system to a base coordinate system to control the movement of the object point along the object path with respect to the base coordinate system.

Furthermore, the object is achieved by a control unit that is designed to predefine, during a synchronous phase, a movement of an object point of the object along an object path in relation to a transport unit coordinate system different from the reference coordinate system, which transport unit coordinate system is moved along the transport trajectory with the transport unit, and to convert at least one path point of the object path from the transport unit coordinate system to a base coordinate system to control the movement of the object with respect to the base coordinate system.

If a plurality of objects is provided, the objects can each have a separate transport unit coordinate system. The object path can be regarded as a geometric construct along which the object point is moved relative to the transport unit. Because the object path is defined in relation to a transport unit coordinate system that is moved along the transport trajectory (which is defined in relation to a reference coordinate system), the object path has a simpler form/geometry/shape than if it were defined directly with respect to the reference coordinate system.

Preferably, the transport system is a long stator linear motor, a planar motor or a continuous conveyor system (for example a conveyor belt system), wherein the object is advantageously part of a kinematics, e.g. a part of a tool. The object point can represent a tool tip, for example.

Preferably, the reference coordinate system corresponds to the base coordinate system. The transport trajectory is thus specified with respect to the base coordinate system.

The transport trajectory is preferably predefined by the transport system and therefore cannot be influenced by the control unit.

Furthermore, the transport trajectory can be previously known, at least in sections, or can be determined, preferably using the position and/or the speed and/or the acceleration of the transport unit.

The object path can be defined in advance with respect to the transport unit coordinate system or can be determined during the movement in relation to the transport unit coordinate system. The object path can, for example, be determined or influenced by an input of a user, e.g. by setting variables, etc.

Preferably, the progress of the object point along the object path is indicated via a path progress parameter, wherein the object path and/or derivatives of the object path along the path progress parameter are converted, preferably point-by-point, from the transport unit coordinate system to a machine coordinate system using a first transformation rule, and the object path converted to the machine coordinate system is converted to the base coordinate system using a second transformation rule.

The path progress parameter can be a one-dimensional quantity representing the progress of the object point along the path. The path progress parameter can thus indicate the position and orientation of the object point.

Instead of the path progress parameter, the position on the object path or another representation of the path progress of the object point on the object path can also be selected directly.

Preferably, the first transformation rule is time-dependent. Furthermore, the second transformation rule can be dependent on the path progress parameter and/or can be time-dependent.

A coupling process can be provided before the synchronous phase, wherein during the coupling process the object is moved along a coupling path to a predetermined starting point in the transport unit coordinate system.

It is particularly advantageous if the coupling path is continuously connected to the object path, preferably continuously up to the second derivative. A continuous transition from the coupling path to the object path is thus achieved for the object, whereby, for example, a stop, a jump in speed or an acceleration jump of the object is avoided.

The coupling path preferably starts at a fixed rest position in the base coordinate system. The object is preferably at rest when it is outside the synchronous phase and, if a coupling operation is provided, outside the coupling operation and, if a decoupling operation is provided, outside the decoupling operation. However, the object point can also be converted from a movement to the coupling path. The coupling path can be planned in the transport unit coordinate system and can subsequently be optimized as required.

The coupling path can be determined, preferably extrapolated via a model, using the position and/or the speed and/or the acceleration of the transport unit. For example, path points or path sections of the coupling path can be continuously determined. The determined path points or path sections of the coupling path can be adapted to the movement of the object coordinate system in order to ensure that the coupling path ends at the start point. The current movement of the object point can also be taken into account when determining the coupling path.

The object can be moved along the object path using a number of axes, wherein kinematic and/or dynamic axis states, preferably axis angles and/or their temporal and/or spatial derivatives, of the number of axes can be determined from the at least one path point of the object path transformed into the base coordinate system by means of an inverse kinematics.

A fixed global coordinate system can be provided as the base coordinate system. However, the base coordinate system can also be moved, in particular if it is arranged on an axis and this axis is not part of the associated kinematics or the movement control of the associated kinematics.

The axis states can also be compared to axis limit values. In this way, it can be ensured that the axis states do not violate the axis limit values, and the change in the axis states is determined such that at least one axis state of an axis is always at an axis limit value in order to obtain a time-optimal movement of the object along the object path.

The axis limit values can be of kinematic nature (speed limit, acceleration limit, jerk limit, etc.). On the other hand, the axis limit values can also be dynamic in nature (force limit value, instantaneous limit value, etc.).

After the synchronous phase, a decoupling operation can be provided, wherein the object point is removed from the object path along a decoupling path during the decoupling operation.

The decoupling path can end at a predetermined end point in the base coordinate system.

Advantageously, the decoupling path is continuously connected to the object path, preferably continuously up to the second derivative. A continuous transition from the object path to the coupling path is thus achieved for the object, whereby, for example, a stop, a jump in speed or an acceleration jump of the object is avoided.

After the synchronous phase, a transition operation can be provided a further synchronous phase, wherein during the transition operation the object point is moved along a transition trajectory from the object path to a further starting point in a further transport unit coordinate system.

When controlling the movement of the object point, it can be ensured that the speed of the object point does not exceed predetermined kinematic and/or dynamic limits, wherein it is particularly advantageous if the controlling of the movement of the object point takes place as far as possible at the kinematic and/or dynamic limit.

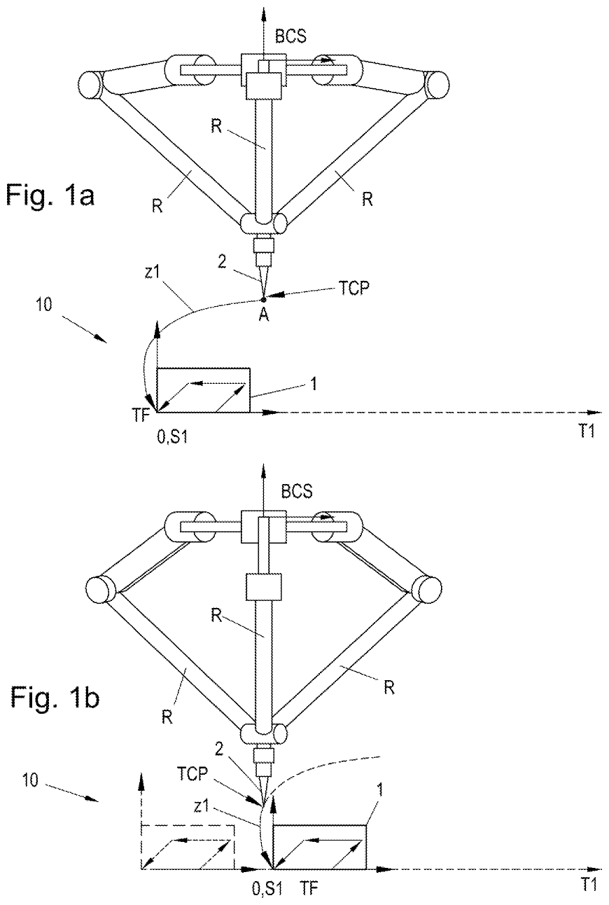

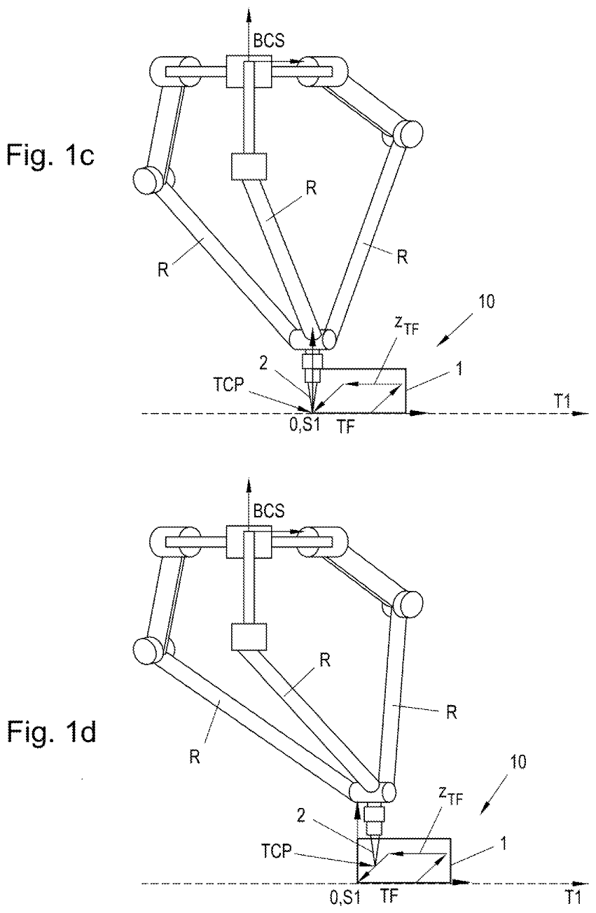

The present invention is described in greater detail below with reference to FIGS. 1 to 3c which show, by way of example, advantageous embodiments of the invention in a schematic and non-limiting manner. The following are shown:

FIG. 1a shows an object point of an object in an initial position,

FIG. 1b shows the object point of the object on the coupling trajectory,

FIG. 1c shows the object point on a starting point of the object path in the transport unit coordinate system,

FIG. 1d shows the object point on the object path in the transport unit coordinate system,

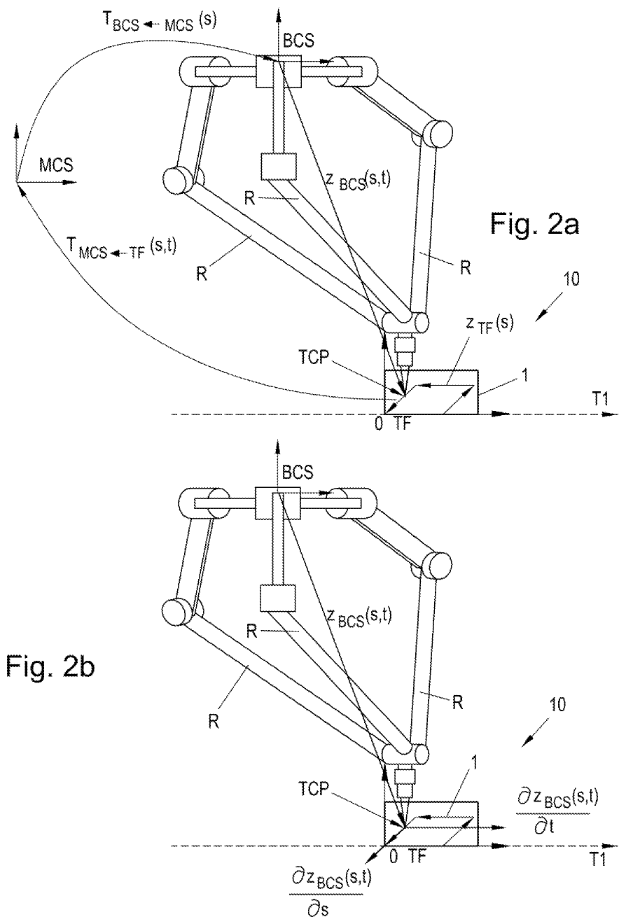

FIG. 2a shows a transformation from the transport unit coordinate system into the base coordinate system via a machine coordinate system,

FIG. 2b shows the temporal and local partial derivative of the object path transformed into the base coordinate system,

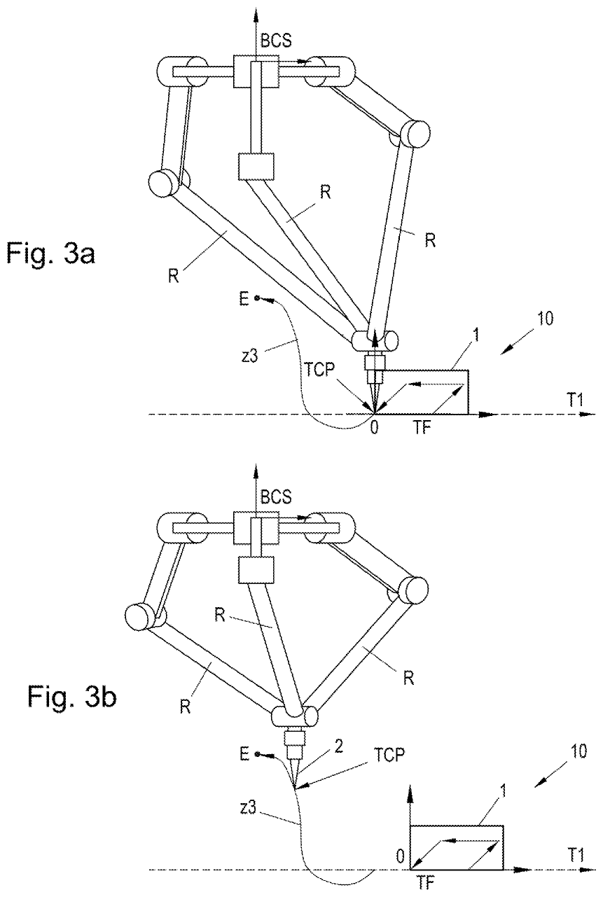

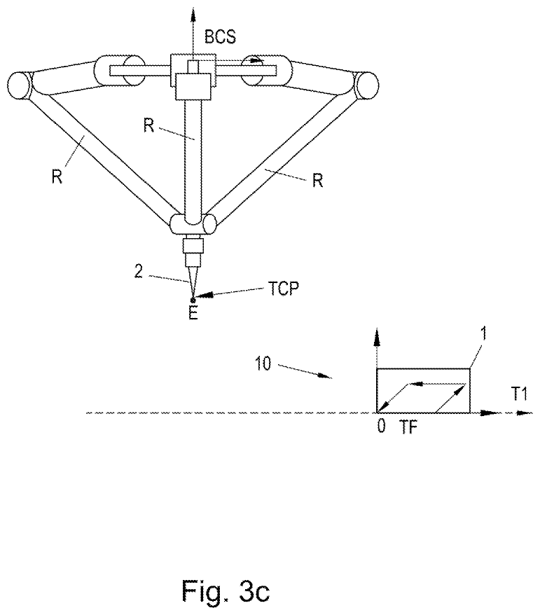

FIG. 3a shows the object point at the beginning of the decoupling path,

FIG. 3b shows the object point on the decoupling path,

FIG. 3c shows the object point on the end position at the end of the decoupling path.

A base coordinate system BCS is defined in each case in the figures. A transport unit 1 of a transport system 10 is provided, which is moved along a transport trajectory Ti. The transport trajectory T1 extends horizontally only as an example. An electromagnetic transport system, for example a planar motor or a long stator linear motor, can be provided as a transport system 10. In the case of a planar motor, a transport plane is provided in which the transport trajectory T1 runs. In a long stator linear motor, a transport path is provided along which a transport trajectory T1 runs. In electromagnetic transport systems, a magnetic field is generated by energizing drive coils (on the transport unit or on the transport path/in the transport plane), which magnetic field, by interacting with drive magnets, generates a propulsive force that causes the transport unit 1 to move. If the drive coils are provided on the transport unit 1, the drive magnets are located on the transport path/in the transport plane. If the drive coils are provided on the transport path/in the transport plane, the drive magnets are located on the transport unit 1. Furthermore, the transport system can be designed as a continuous conveying system (for example as a conveyor belt system). In this case, the transport unit represents the unit that is movable relative to the transport path or a part of said unit, i.e., for example, in a conveyor belt system, the conveyor belt itself or a belt section of the conveyor belt. The transport trajectory T1 is defined with respect to a reference coordinate system, i.e., in the illustrated embodiment with respect to the base coordinate system BCS. Transport systems 10, in particular long stator linear motors and planar motors, are well known, which is why they are not described in more detail at this point. In the figures, only a section of a transport system 10 is shown, wherein a section of the transport trajectory T1 and an associated transport unit 1 can be seen.

An object 2 is also provided, wherein an object point TCP of the object 2 is to be moved along an object path z_{TF}. The object point TCP of the object 2 can be freely defined on the object 2. For example, a part, for example a tool, of a for example serial kinematics can be provided as the object 2, wherein, for example, a tool tip can be defined as the object point TCP.

According to the prior art, the movement of the object point TCP is controlled by planning the object path z_{TF} directly with respect to the coordinate system in which the transport trajectory is defined, i.e., in the exemplary embodiment shown with respect to the base coordinate system BCS. However, this is only possible if the transport trajectory T1 and the object path z_{TF} are known in advance and the object path z_{TF} can influence the transport trajectory T1.

According to the invention, however, the object path z_{TF} is defined in relation to a transport unit coordinate system TF, wherein the transport unit coordinate system TF does not correspond to the reference coordinate system, i.e., differs from the reference coordinate system. In the embodiment shown, the reference coordinate system corresponds to the base coordinate system BCS, from which it follows that the transport unit coordinate system TF does not correspond to the base coordinate system BCS. The object path z_{TF} fundamentally describes the path along which the object point TCP moves in relation to the transport unit coordinate system TF. Because the transport unit coordinate system TF is moved with the transport unit 1, the object path z_{TF} is moved with the transport unit 1. At least one path point of the object path z_{TF} is transformed from the transport unit coordinate system TF to the first coordinate system (in this case the base coordinate system BCS).

If a plurality of transport units 1 are provided, the transport units 1 can each have a separate transport unit coordinate system TF. Thus, a synchronous phase P2 can be provided in each case with respect to the transport units 1, during which a movement of the object point TCP along an object path z_{TF} in relation to the transport unit coordinate system TF belonging to the transport unit 1, which transport unit coordinate system is different from the reference coordinate system, is predefined, wherein the transport unit coordinate system TF is moved along the transport trajectory T1 with the transport unit 1, and wherein at least one path point of the object path z_{TF} is converted from the transport unit coordinate system TF to a base coordinate system BCS to control the movement of the object point TCP along the object path z_{TF} with respect to the base coordinate system BCS. Preferably, the synchronous phases P2 are provided sequentially, whereby the movement of the object point TCP along the respective object paths z_{TF} is sequential. The transition from one synchronous phase P2 to the next synchronous phase P2 can take place via a decoupling process P3 from the one synchronous phase and a subsequent coupling process P1 to the next synchronous phase P2.

It can be provided that the transport unit coordinate system TF is fixedly predefined and cannot be influenced, for example by providing an external transport device 1.

The transport trajectory T1 can be known or unknown in advance. If the transport trajectory T1 is unknown, it can also be determined, preferably extrapolated via a model, using the position and/or the speed and/or the acceleration of the transport unit 1.

By way of example, a rhombus can be provided as the object path z_{TF}. However, any one-dimensional, two-dimensional (or in a multidimensional transport unit coordinate system TF also multidimensional) object paths z_{TF} are possible, for example circles, cuboids, helical lines, etc. The object path z_{TF} can be fixedly predefined with respect to the transport unit coordinate system TF or can also be determined during the synchronous phase P2 or during a coupling operation P1. In addition, the object path z_{TF} can be closed in itself, have one or more circuits (or a fraction of integer circuits), etc.

The base coordinate system BCS and/or transport unit coordinate system TF and/or reference coordinate system (which in this case corresponds to the base coordinate system BCS) are defined only two-dimensionally for simplicity and can also represent, for example, a three-dimensional, multi-dimensional Cartesian or non-Cartesian coordinate system. The base coordinate system BCS and/or transport unit coordinate system TF and reference coordinate system can also represent a multi-dimensional (for example, a 6-dimensional) non-Cartesian coordinate system.

In FIG. 1a, the object point TCP is in its starting position A, which is preferably arranged in a stationary manner in the base coordinate system BCS. In the meantime, the transport unit 1 moves along the transport trajectory T1 in the reference coordinate system, i.e., in this case in the base coordinate system BCS. For the object point TCP, a transport unit coordinate system TF different from the reference coordinate system is provided.

Starting from FIG. 1a, a coupling operation P1 follows, wherein the object point TCP is moved along a coupling path z1 to a predefined starting point S1 in the transport unit coordinate system TF. The starting point S1 thus moves together with the transport unit coordinate system TF along the transport trajectory T1. For example, the origin 0 of the transport unit coordinate system TF can be provided as starting point Si, as is shown in the figures. The coupling path z1 advantageously starts at the starting position A in the reference coordinate system (in this case the base coordinate system BCS) and is preferably planned in the transport unit coordinate system TF. Thus, the object point TCP starts at the starting position A (FIG. 1a), follows the coupling path z1 (FIG. 1b) and finally arrives at the starting point S1 in the transport unit coordinate system TF (FIG. 1c).

Because the transport unit 1 performs a movement along the transport trajectory T1 with respect to the reference coordinate system (in this case the base coordinate system BCS), the coupling path z1 (and thus also the starting position A) can be moved along with the transport unit 1 and thus also with the transport unit coordinate system TF. In the calculation of the coupling path z1, the position/speed/acceleration of the object point TCP can also be taken into account in order to ensure a continuous transition of the object point TCP to the coupling path z1.

Furthermore, at least a section of the coupling path z1 can be calculated based on the position and/or the speed and/or the acceleration of the transport unit 1. The coupling path z1 can also be adapted to the current position and/or speed and/or acceleration, preferably continuously. It can thus be ensured that the movement of the transport unit 1 (and thus of the starting point S1 in the transport unit coordinate system TK, in this case the origin 0 of the transport unit coordinate system TF) along the transport trajectory T1 is taken into account and that the coupling path z1 also actually opens at the starting point Si.

If the starting point S1 is, as shown in FIG. 1d, on the planned object path z_{TF}, it is advantageous if the coupling path z1 opening into the coupling coordinates S1 is continuous to the planned object path z_{TF}, preferably continuous up to the first, second or higher derivative. Continuous up to the first derivative means a continuous speed, continuous up to the second derivative means a continuous acceleration (i.e., an acceleration without a jump). As soon as the object point TCP has passed through the coupling path z1, it is possible to transition directly to the object path z_{TF} via the coupling coordinates S1.

As mentioned, FIG. 1a shows the object point TCP in its starting position A, whereupon the coupling operation P1 is started. In FIG. 1b, the object point TCP is already located on the coupling path z1 and in FIG. 1c already at the end of the coupling path z1 at the starting point S1. Note that in FIG. 1b, the transport unit 1 and thus also the transport unit coordinate system TF have already moved further along the transport trajectory T1 in relation to FIG. 1a. For a clearer illustration, the position of the transport unit 1 and the transport unit coordinate system TF from FIG. 1a is shown by dashed lines in FIG. 1b.

In FIG. 1c, the object point TCP has reached the coupling coordinate S1 in the transport unit coordinate system TF, i.e., in this case the origin 0 of the transport unit coordinate system TF (in FIG. 1c, the transport unit 1 has moved further along the transport trajectory T1 compared to FIG. 1b). The coupling operation P1 is thus completed and the synchronous phase P2 can be started.

As shown in FIG. 1d, the object point TCP follows the object path z_{TF} in the synchronous phase P2, wherein the object path z_{TF} is predefined in relation to the transport unit coordinate system TF. Because the transport unit coordinate system TF is moved along the transport trajectory T1 with the transport unit 1, according to the invention at least a section of the object path z_{TF} is converted from the transport unit coordinate system TF to the base coordinate system BCS. Thus, at least one respective section of the movement sequence of the object point TCP with respect to the base coordinate system BCS is always known, whereby the object 2 can be actuated accordingly.

After the end of a synchronous phase P2, a decoupling operation P3 can be provided during which a decoupling path z3 is provided for the object point TCP, as is shown by way of example in FIGS. 3a, 3b and 3c. The decoupling path z3 starts on the object path z_{TF}, preferably at a predetermined decoupling point, for example at the origin, and preferably ends at an end position E in the base coordinate system BCS. It is advantageous if a continuous transition is predefined from the object path z_{TF} to the decoupling path z3. In this case, the transition can run continuously up to the first, second or higher derivative. In FIG. 3a, the object point TCP is at the origin 0 as the decoupling point, and in FIG. 3b on the decoupling path z3 and in FIG. 3c at the end of the decoupling path z3 at the end position E.

If a coupling operation P1 and a decoupling operation P3 are provided, the end point E can correspond to the starting point A. The decoupling path z3 is advantageously calculated in the base coordinate system BCS in which the end position E is also located.

Basically, the entire object path z_{TF} can be converted from the transport unit coordinate system TF to the base coordinate system BCS. However, it is advantageous if path points or path sections are transformed in each case, whereby time-optimal control of the movement of the object 2 can take place. The current positioning of the object point TCP on the object path z_{TF} can be viewed as a function of a path progress parameter s. The path progress parameter s can describe the progress of the object point TCP on the object path z_{TF} as a scalar parameter.

The conversion to the base coordinate system BCS can thus take place by converting the object path z_{TF} and/or derivatives according to the path progress parameter s and/or the time, preferably converted point-by-point or section-by-section, to a machine coordinate system MCS. This can be done by means of a time-dependent transformation rule T_{MCS←TF}(t).

Furthermore, the section of the object path z_{TF} converted to the machine coordinate system MCS can in turn be converted from the machine coordinate system MCS to the base coordinate system BCS, preferably point-by-point or section-by-section. This can take place by means of a transformation rule T_{BCS←MCS}(s) dependent on the path progress parameter s, in particular if conversion to the machine coordinate system MCS was done previously by means of a time-dependent transformation rule T_{MCS←TF}(t).

However, the transformation from the machine coordinate system MCS to the base coordinate system BCS can also be carried out by means of a time-dependent transformation rule T_{BCS←MCS}(t) or by means of a transformation rule T_{BCS←MCS}(s,t) dependent on the time and the path progress parameter s.

The transport trajectory T1 can be assumed to be known for the time horizon for which the conversion to the base coordinate system BCS takes place. The machine coordinate system MCS can also correspond to a fixed global coordinate system. As mentioned, it is of course also possible to transform directly to the base coordinate system BCS without previously transforming to the machine coordinate system MCS.

The time-dependent transformation rule T_{MCS←TF}(t) or T_{BCS←MCS}(t) includes the time-dependent movement of the transport unit coordinate system TF with the transport unit 1 along the transport trajectory Ti.

The time-dependent transformation rules T_{MCS←TF}(t) and T_{BCS←MCS}(S) or T_{MCS←TF}(s) and T_{BCS←MCS}(t) dependent on the path progress parameter s result in new partial derivatives with respect to the path progress parameter s

$$\frac{\partial {z}_{BCS} ( s , t )}{\partial s}$$

and with respect to the time t

$$\frac{\partial {z}_{BCS} ( s , t )}{\partial s}$$

—starting from the second derivative, mixed terms also result.

The object point TCP can be moved along the object path z_{TF} using a number of axes R connected to the object 2. Kinematic axis states, for example axis angles and/or derivatives thereof, can be used for the axes R. The kinematic axis states can be predefined with respect to a Cartesian coordinate system, for example an axis coordinate system ACS. The partial derivatives of the object path

$$\frac{\partial {z}_{BCS} ( s , t )}{\partial s} , … , \frac{\partial {z}_{BCS} ( s , t )}{\partial s} , …$$

can thus be converted to the axis coordinate system ACS by means of an inverse kinematics:

$$( \frac{\partial {q}_{ACS} ( s , t )}{\partial s} , \frac{\partial {q}_{ACS} ( s , t )}{\partial t} , … ) .$$

It is thus also possible to calculate a time derivative of the path progress parameter s(t) in such a way that at least one kinematic axis state of an axis R lies within axis limit values. The speed of the advancing object point TCP along the object path z_{TF} can be represented by the time profile of the path progress parameter s(t).

For example, a speed \dot{q}_{ACS} of an axis R can be provided as a kinematic axis state, wherein a maximum speed \dot{q}_{ACS,max} and/or a minimum speed \dot{q}_{ACS,min} is provided as an axis limit value. This ensures that the speed \dot{q}_{ACS} of the axis R does not exceed the maximum speed \dot{q}_{ACS,max} and/or fall below the minimum speed \dot{q}_{ACS,min}L

$${\dot{q}}_{ACS , max} \geq {\dot{q}}_{ACS} = \frac{\partial {q}_{ACS} ( s , t )}{\partial s} \dot{s} + \frac{\partial {q}_{ACS} ( s , t )}{\partial t} ;$$

$${\dot{q}}_{ACS , min} \leq {\dot{q}}_{ACS} = \frac{\partial {q}_{ACS} ( s , t )}{\partial s} \dot{s} + \frac{\partial {q}_{ACS} ( s , t )}{\partial t} .$$

Using these relationships, the time derivative of the path progress parameter s can be determined in order to determine how quickly the path progress parameter s can change without the axis states exceeding the axis limit values.

It can also be provided that a kinematic axis state of an axis R is always at an axis limit value \dot{q}_{ACS,max}, \dot{q}_{ACS,min} to provide an optimal movement of the object point TCP along the object path z_{TF} (for example with respect to time). The factor can, for example, represent a minimum time, whereby the movement is time-optimized. If the factor represents a minimum energy, the movement is minimal with respect to the energy that occurs.

To ensure that the object point TCP follows the object path z_{TF}, for example, the path progress parameter s(t) can be evaluated for the current time t, and the resulting position z_{TF}(t) on the object path z_{TF} can be converted to the base coordinate system BCS, from which, in turn, the axis angles can be determined using the inverse kinematics. If the movement of the transport unit coordinate system TF along the transport trajectory T1 used for planning deviates from the actual movement, the axis limit values may be exceeded.

Preferably, in the synchronous phase P2 and/or during the coupling operation P1 and/or during the decoupling operation P3, it is ensured that a speed and/or an acceleration and/or a jerk of the object point TCP does not violate corresponding axis limit values.

1. A method for controlling a movement of an object in relation to a transport unit of a transport system, wherein the transport unit is moved along a predefined transport trajectory with respect to a reference coordinate system, wherein a synchronous phase is provided, during which a movement of an object point of the object along an object path with respect to a transport unit coordinate system, different from the reference coordinate system, is predefined during the synchronous phase, wherein the transport unit coordinate system containing the transport unit is moved along the transport trajectory, wherein the transport trajectory is determined at least in sections using the position and/or the s wed and/or the acceleration of the transport unit, and wherein at least one path point of the object path is transformed from the transport unit coordinate system to a base coordinate system, to control the movement of the object point along the object path with respect to the base coordinate system.

2. The method according to claim 1, wherein the reference coordinate system corresponds to the base coordinate system.

3. The method according to claim 1, wherein a fixed global coordinate system is used as the base coordinate system.

4. The method according to claim 1, wherein the transport trajectory is predefined by the transport system.

5.-7. (canceled)

8. The method according to claim 1, wherein the object path is defined in advance in relation to the transport unit coordinate system.

9. The method according to claim 1, wherein the progress of the object point along the object path is specified as a path progress parameter, wherein the object path and/or derivatives of the parameterized object path along the path progress parameter are converted from the transport unit coordinate system to a machine coordinate system at least in sections, preferably point-by-point, using a first transformation rule, and wherein the object path converted to the machine coordinate system is converted to the base coordinate system using a second transformation rule.

10. The method according to claim 9, wherein, the first transformation rule is time-dependent.

11. The method according to claim 9, wherein the second transformation rule depends on the path progress parameter.

12. The method according to claim 9, wherein the second transformation rule is time-dependent.

13. The method according to claim 9, wherein the first transformation rule depends on the path progress parameter, and wherein the second transformation rule is time-dependent.

14. The method according to claim 1, wherein a coupling operation is provided before the synchronous phase, wherein during the coupling operation the object point is moved along a coupling path to a predetermined starting point in the transport unit coordinate system.

15. The method according to claim 14, wherein the starting point is arranged on the object path.

16. The method according to claim 15, wherein the coupling path is continuously connected to the object path.

17. The method according to claim 14, wherein the coupling path starts at a fixed rest position in the base coordinate system.

18. The method according to claim 14, wherein the coupling path the object point is transferred from a movement to the coupling path.

19. The method according to claim 14, wherein the coupling path is determined, preferably extrapolated via a model, using the position anchor the speed and/or the acceleration of the transport unit.

20. The method according to claim 1, wherein the object is moved along the object path using a number of axes, and wherein kinematic and/or dynamic axis states, preferably axis angles and/or their temporal and/or spatial derivatives, of the number of axes Ware determined from the at least one path point of the object path transformed into the base coordinate system by inverse kinematics.

21. The method according to claim 20, wherein the axis states are compared to axis limit values.

22. The method according to claim 1, wherein after the synchronous phase, a decoupling operation is provided, wherein during the decoupling operation the object point is removed from the object path along a decoupling path.

23. The method according to claim 22, wherein the decoupling path is continuously connected to the object path.

24. The method according to claim 22, wherein the decoupling path terminates at a predetermined endpoint in the base coordinate system.

25. The method according to claim 1, wherein after the synchronous phase, a transition operation is provided for a further synchronous phase, wherein during the transition operation the object point is moved along a transition trajectory from the object path to a further starting point in a further transport unit coordinate system.

26. The method according to claim 1, wherein when controlling the movement of the object point, it is ensured that the speed of the object point does not exceed predetermined kinematic limits.

27. The method according to claim 26, wherein the movement of the object point is controlled as far as possible at a predetermined kinematic limit.

28. A system comprising a transport system having a transport unit moved along a transport trajectory that is predetermined with respect to a reference coordinate system and an object that is moved in relation to the transport unit, wherein a control unit is provided that is designed to predefine, during a synchronous phase, a movement of an object point of the object along an object path in relation to a transport unit coordinate system different from the reference coordinate system, which transport unit coordinate system is moved along the transport trajectory with the transport unit, wherein the transport trajectory can be determined at least in sections using the position and/or the speed and/or the acceleration of the transport unit, and to convert at least one path point of the object path from the transport unit coordinate system to a base coordinate system different from the reference coordinate system, to control the movement of the object point with respect to the base coordinate system.

29. The system according to claim 28, wherein the transport system is a long stator linear motor, a planar motor or a conveyor belt.

30. The system according to claim 28, wherein the object is part of a kinematics.
